(19) United States
(12) Patent Application Publication
(10) Pub. No.: US 2008/0255882 A1
(43) Pub. Date: Oct. 16, 2008

(54) SYSTEM AND METHOD FOR MAINTAINING MEDICATION ADMINISTRATOR RECORDS

(76) Inventors: Gary W. Chin, Toronto (CA); Ambrose C.H. Au, Markham (CA)

Correspondence Address: BERESKIN AND PARR, 40 KING STREET WEST, BOX 401, TORONTO, ON, M5H 3Y2, CA

(21) Appl. No.: 12/100,517

(22) Filed: Apr. 10, 2008

Related U.S. Application Data
(60) Provisional application No. 60/910,969, filed on Apr. 10, 2007.

(51) Int. Cl. G06Q 50/00

(52) U.S. Cl. 705/3

(57) ABSTRACT

Several embodiments of medication administrator record keeping systems (MAR Systems). The MAR systems include MAR forms and a writing system adapted to permit health care providers to write onto the forms and to electronically capture pen stroke information corresponding to the written information. The MAR forms are associated with specific patients. The penstroke information is used to update an image of the MAR forms. The pen stroke information is also used to update information in a MAR database module. The MAR database module may be updated manually be a technician or automatically by a MAR data processing module. Some MAR forms may include action fields that trigger an action. For example, some MAR forms include a reorder action field that triggers a process of reordering meds for a patient.

This is an application claiming the benefit under 35 USC 119(e) of U.S. Provisional Patent Application Ser. No. 60/910,969 filed Apr. 10, 2007. U.S. Ser. No. 60/910,969 is incorporated herein, in its entirety, by this reference to it.

### FIELD

The embodiments described herein relate to systems and methods relating to the administration of medication to patients.

### BACKGROUND

Nurses, doctors and other health care providers working within an inpatient health-care facility (a “patient facility”), such as a nursing home or a hospital, routinely administer medicinal doses to residents. In some jurisdictions, health care providers must record all medicinal dose administrations on paper forms called Medication Administration Record (“MAR”) forms.

Typically, a pharmacist or an administrator with access to a database of patient information relating to patients residing in a patient facility will pre-print the MAR forms with a resident's personal information, list of medication, dosage and time when the medicinal dose should be administered. Each medication prescribed for a patient has a corresponding section on the MAR form. The pre-printed MAR forms are delivered to the patient facility. A health care provider records the administration of each dose of the medication. The MAR form is typically filed in each patient's chart, although MAR forms may also be collected together for patients present in all or part of a patient facility at any particular time.

When a dose of medication is administered to a resident, the health care provider administering the dose records administration of the dose by initialing the corresponding box on the MAR form associated with the resident. If there are any changes or updates to the pre-printed information on the MAR form, such as medication, dose or administration time, the health care provider will manually record the change in writing on the resident's MAR form. All manually modified MAR forms are then delivered back to the pharmacist or administrator, and the modified information is used to update the resident database.

Typically, a MAR form is used for one month and the manually modified forms are typically only returned to the pharmacy or specialized administrator at the end of the month. As a result of the delay, there is often a discrepancy between the resident information recorded in the database and the actual information provided on the MAR form (i.e. the manual modifications written by the nurse).

Moreover, commonly a health care provider may not record administration of a medication on the MAR form at the time the medicinal dose is administered. Instead, a health care provider may administer medication to all residents in a “round” and then record all administrations on MAR forms (i.e. by initialing the MAR form) in a batch after completing the round. This practice does not conform to the requirements of some regulatory bodies and some patient facilities. Current systems and methods are limited in their ability to track instances of a health care provider recording all administrations for a round in a batch.

Some prescriptions specify that a medication is to be administered to a patient on an as-needed or “pro re nata” basis. A health care provider administers the medication to the patient when the patient requires it. The health care provider records the administration of the medication and the circumstances and/or reasons for administering the PRN medication. However, a health care provider may forget to document the outcome or result of the PRN administration in the PRN documentation field. Current systems and methods are limited in their ability to track any PRN medication that was administered and not documented, or remind the health care provider to document the PRN medication administration outcome.

Accordingly, there is a need for an improved system and method for maintaining medication administrator records.

### SUMMARY

In some embodiments, the present invention provides a MAR system with an administration node, a patient facility client node and MAR forms. The administration node includes a MAR database module for recording patient information and medication information for each of a plurality of patients. The patient facility client nodes include a writing system adapted to allow a health care provider to write directly onto a MAR form and to electronically capture pen stroke information corresponding to the information written onto the MAR form. The pen stroke information is transmitted from the electronic pen to a MAR processing module in the administration node, which decodes the pen stroke information and updates an image of the corresponding MAR form in the MAR database module. Each MAR form is associated with a particular patient and can be viewed by a technician at the administration module.

In some embodiments, information from the image of the MAR form is used by a technician to update corresponding information in the MAR database module. In other embodiments, a handwriting recognition system is provided in the administration module to automatically update information in the MAR database module based on the pen stroke information.

In some embodiments, a pharmacy client node is provided and the system includes a prescription processing module. The prescription processing module may optionally be integrated with the MAR data processing module and may reside on the administration node. In other embodiments, the prescription processing module may reside on a pharmacy client node.

In some embodiments, the MAR forms include one or more action fields. If a health care provider marks an action field, the MAR system may automatically initiate an action in response. For example, a MAR form may include a reorder field. If the reorder field is marked, the MAR data processing module or a prescription processing module may automatically order additional medication from a pharmacy. Typically, the request for additional medication will be transmitted to a pharmacy client node.

A MAR system may include different type of MAR forms, including forms for recording information relating to the administration of medications prescribed on an as-needed or “PRN” basis.

In another embodiment, the invention provides system for maintaining medication administrator records comprising: an administration node including: a MAR database module for recording information relating the administration of medications to patients; and a MAR data processing module for receiving pen stroke information and for recording data corresponding to the pen stroke information in the MAR database module; one or more patient facility client nodes, each of the patient facility client nodes including: a writing system adapted to record pen stroke corresponding to information written by a health care provider onto a MAR form; and a health care provider workstation adapted to receive the pen stroke information from the writing system and to transmit the pen stroke information to the MAR data processing module.

In another embodiment, the present invention provides A system for maintaining medication administrator records comprising: a writing system adapted to record pen stroke corresponding to information written by a health care provider onto a MAR form; and an administration node including: a MAR database module for recording information relating the administration of medications to patients; and a MAR data processing module for receiving pen stroke information from the writing system and for recording data corresponding to the pen stroke information in the MAR database module.

In some embodiments, the MAR system further includes a plurality of MAR forms corresponding to patients, wherein each of MAR forms includes one or more fields for recording medication information relating to the administration of medication to a respective patient, and wherein the MAR database includes a data field for recording data corresponding to the medication information.

In some embodiments, the MAR data processing module is configured to convert the pen stroke information into an image of the MAR form including the medication information to which the pen stroke information corresponds and to record the image in the MAR database module.

In some embodiments, the MAR data processing module progressively updates the image of the MAR form in response to additional pen stroke information corresponding to additional medication information being written onto a corresponding MAR form.

In some embodiments, the MAR form includes a digital map pattern, and wherein the writing system includes an electronic pen adapted to electronically record the pen stroke information by optically scanning the digital map pattern.

In some embodiments, the image is converted into data recorded in data field in the MAR database module through a manual transcribing process.

In some embodiments, the MAR database module is configured to convert the pen stroke information into data corresponding to the medication information and to record the data in the MAR database module.

In some embodiments, the MAR database module includes a hand writing recognition module for converting the pen stroke information into data corresponding to the medication information.

In some embodiments, the MAR system further includes a prescription processing module for providing prescription information to a pharmacy.

In some embodiments, at least some of the MAR forms include an action field and wherein, in response to medication information being written into the action field, a corresponding action is taken.

In some embodiments, each of MAR forms includes a patient information section having a plurality of fields relating to a patient, wherein the field are automatically populated with information relating to the patient.

In some embodiments, each of the MAR forms includes one or more prescription section have a plurality of fields relating to medications prescribed for the patient, wherein at least some of the field are automatically populated with information relating to the patient's medications.

In some embodiments, the fields in the prescription section include a medication field for identifying a medication prescribed for the patient and a dosage field for setting out a prescribed dosage and a plurality of date/time fields for marking the administration of a dose of the medication.

In some embodiment, the fields in the prescription section include a reorder field, and wherein the administration node is configured to automatically order an additional supply of the corresponding medication if the reorder field is marked.

Some embodiments of the invention provide a method of maintaining medication administration records comprising: providing one or more forms, wherein each of the MAR forms corresponds to a patient; receiving pen stroke information corresponding to medication information written by a health care provider onto a particular MAR form; combining the pen stroke information with an existing image of the particular MAR to provide an updated image of the particular MAR form wherein the update image includes the medication information.

In some embodiments, the method includes converting the pen stroke information into data corresponding to the medication information and recording the data into a data field in the MAR database module.

In some embodiments, the MAR form includes at least one reorder action field in a medication section, and wherein the medication section corresponds to a particular medication prescribed for a respective patient, the method further comprising: analyzing the pen stroke information to determine whether the reorder action field has been marked; if the reorder action field has been marked, then ordering an additional supply of the medication from a pharmacy.

In some embodiments, the additional supply of the medication is automatically ordered using previously recorded patient information.

In some embodiments, the method includes providing one or more MAR forms including, for each of the patients, printing one or more MAR forms containing patient information and medication information specific to the patient.

In some embodiments, the patient information and medication information specific to the patient is obtained from a MAR database module.

In some embodiments, the method further includes printing a replacement MAR form corresponding to an original MAR form, including printing information written or marked on the original MAR form onto the replacement MAR form.

In another aspect, a MAR system for a patient facility may be provided in a single node. The single node may include a MAR database module and a MAR data processing module for receiving pen stroke information from an electronic pen or other writing system coupled to the node. The single node will include a technician workstation and may optionally include a prescription processing module.

### BRIEF DESCRIPTION OF THE DRAWINGS

Several embodiments of the present invention will now be described in detail with reference to the drawings, in which:

FIG. 1 illustrates an embodiment of a medication administrator record keeping system;

FIG. 2 illustrates an exemplary medication administration form of the embodiment of FIG. 1;

FIG. 3 illustrates an exemplary PRN detail form of the embodiment of FIG. 1;

FIG. 4 is a flowchart illustrating a method of providing MAR forms for patients;

FIG. 5 is a flowchart illustrating the use of a MAR form to record the administration of medications;

### DETAILED DESCRIPTION OF EXEMPLARY EMBODIMENTS

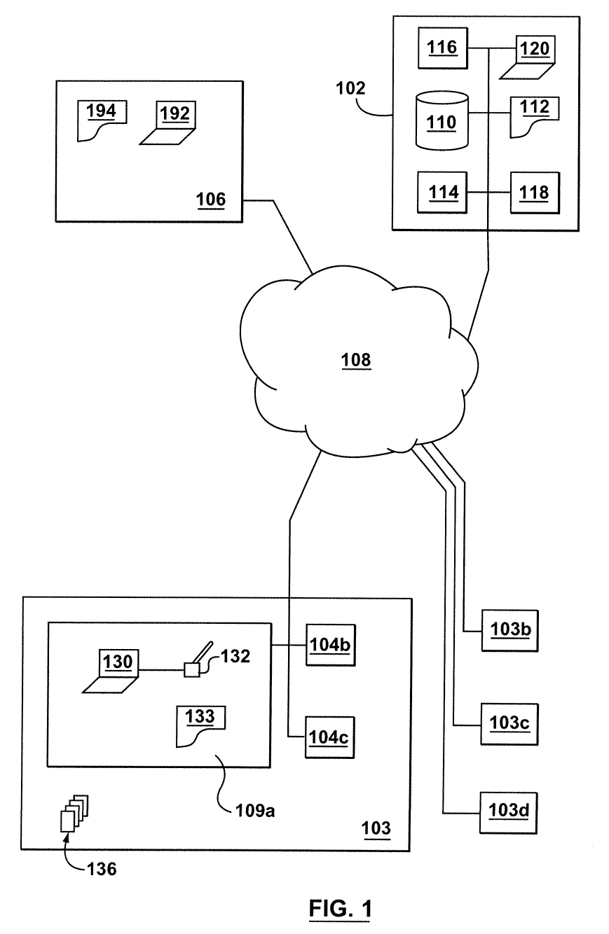

Reference is first made to FIG. 1, which illustrates a medication administrator record keeping system (“MAR system”) 100. MAR system 100 includes a MAR administration node 102, a plurality of patient facility client nodes 104, a pharmacy client node 106, a plurality of MAR forms 136 and a network 108. Each of the administration node 102, and the client nodes 104, 106 are coupled to the network 108 to allow the server and the clients to communicate with one another. Network 108 may be any type of communication network such as the Internet, a LAN, and may include wired and wireless communication devices and links. Patient facility client nodes are typically located in a patient facility 103.

Administration node 102 includes a MAR database module 110, a printer 112, a MAR data processing module 114, a prescription processing module 116, a user interface module 118 and a technician workstation 120, each of which is coupled to a server network 122 to allow communication between the components of the administration node 102. Server network 122 is coupled to network 108 through an external network interface 124. MAR data processing module 114, prescription processing module 116 and user interface module 118 are software components that reside (or execute or operate) on a computer or other computer device within the administration node. For example, these components may reside on the technician workstation 120. These modules may operate on the same computer or on different computers. Where two of the modules reside on the same computer, the modules may communicate internally within the computer rather than through the server network 122. The modules may also be combined into a single software component or may share software components that are common to more than one module. MAR data processing module 114 is coupled to network 108 to communicate with the patient facility client nodes 104. MAR data processing module 114 provides communication services between the administration node 102 and the patient facility client nodes 104. In addition, the MAR data processing module 114 also provides data processing services to process information received form the patient facility client nodes. Prescription processing module 116 is configured to communicate with pharmacy client node 106. User interface module 118 is configured to provide a user interface for a technician using the technician workstation to allow the technician to retrieve information from and to modify or record information in the MAR database module 110.

In other embodiments, the prescription processing module 116 may reside in a pharmacy client node 106 and may obtain prescription information from the MAR database module 110 directly. The prescription processing module may do so by periodically querying the MAR database module (which may include an interface for receiving and responding to such queries) for new prescriptions, or in response to messages indicating that a new prescription has been requested.

Any facility or location at which a patient is located or may be located may be a patient facility 103. For example, a hospital, hospice, nursing home or a private home may be a patient facility. Typically, a patient facility will be an in-patient care facility. Each patient facility 103 has one or more patient facility client nodes 104. Each patient facility client node 104 includes a health care provider workstation 130 and an electronic pen 132 coupled to the health care practitioner workstation. The health care provider workstation 130 may be any type of computing device capable of communicating with the electronic pen (or other writing system in which a paper and a corresponding electronic version of written information may be recorded) and communicating with the administration node 102.

In MAR system 100, some or all of the patient facility client nodes 104 may also include a printer 133 coupled to the health care provider workstation 130. The printer 133 may be coupled directly to the patient facility client node 104 or may be coupled through a network. A printer may be shared among more than one patient facility client node 104 and may also be shared with other computing devices.

At each patient facility client node 104, the electronic pen 132 is coupled to the health care practitioner workstation 130 to facilitate data transfer and other communication between them. The electronic pen 132 may be coupled to the health care practitioner workstation 130 through a wired or wireless communication link. For example, in some patient facility client nodes 104, the electronic pen 132 may be placed in a cradle that couples the electronic pen 132 to the health care practitioner workstation 130 through a universal serial bus (USB) connection. In some patient facility client nodes, the electronic pen 132 may communicate with its respective health care practitioner workstation 130 through a wireless Bluetooth (IEEE 802.15.1), Wi-FI (IEEE 802.11/a/b/g/n) or another wireless communication network. The use and operation of an electronic pen 132 in a MAR system 100 is described in greater detail below. Some patient facility client nodes 104 may include two or more electronic pens 132.

In MAR system 100, there is a plurality of patient facility client nodes. In other embodiments, there may be a single patient facility that includes a single patient facility client node.

Various types of electronic pens may be used in a MAR system. One type of electronic pen suitable for use with the present invention includes an ink writing system for writing on paper and an optical scanning system for scanning a digital map pattern printed on the paper to electronically record pen stroke information corresponding to the information written on the paper. A digital map pattern based electronic pen system is licensed by Anoto AB to various manufacturers and is further described at www.anoto.com and other publicly available information sources. Anoto digital pen and paper systems are available from Logitech™ (the Logitech io2™Digital Pen), Maxell™ (Penit Digital Pen) and other manufacturers.

The present invention is not limited to the use of Anoto based digital pen and paper systems, or to the use of papers that include a digital map pattern. In some embodiments, the electronic pen 132 of MAR system 100 may be replaced with an alternative writing system for electronically recording pen stroke information written onto a MAR form. The pen stroke information may be any type of information that is electronically recorded by the writing system and that corresponds to information written onto a MAR form by a health care provider. Any writing system that allows both writing onto a MAR form and electronic recordation of such pen stroke information may be used. For example, Epos Technologies Limited of Israel provides an electronic pen under the name Digital Pen that uses a pen with ultrasonic transmitters and a receiver to detect information written onto a paper with the Digital Pen. More information about this system is available at www.epos-ps.com. Other systems in which a paper sheet is placed on a digital tablet and in which information written onto the form is sensed either through pressure sensing, proximity sensing or other methods for detecting the presence and movement of a writing instrument, which may be an ordinary pen or pencil, or a specific writing instrument containing specialized transmitters, transducers or other detectable components.

In MAR system 100, every MAR form 136 can be distinguished from any other MAR form using the Anoto electronic pen technology. Each MAR form 136 includes a digital map pattern printed in at least the parts of the MAR form that could be used to record information using an electronic pen. Typically, the digital map pattern will be provided on all or substantially all of the MAR form. The digital map pattern used on each MAR form is unique, at least with respect to other MAR forms in a particular MAR system. Each digital map pattern can be uniquely identified by scanning a small portion of the form with the optical scanning system of the electronic pen. When a health care provider (or any other person) writes on a MAR form 136 using the digital pen, the optical scanning system scans the digital map pattern and the electronic pen generates pen stroke information corresponding to the information written on the form. The pen stroke information also corresponds to the position of the written information on the form and the pen stroke information can be used to reproduce an image of any written pen strokes made on the MAR form. Relatively small sections of the digital map pattern, corresponding to an area in which a few letters may be written, on a MAR form are unique from all other relatively small sections on all other MAR forms. The penstroke information recorded by the electronic pen may be used to identify the particular MAR form 136. The electronic pen may thus be used to write on different MAR forms 136 in sequence and the writing on each separate paper form is correlated to the particular form on which it is written. Each MAR form 136 in a MAR system 100 is assigned a unique paper ID. The list of all paper ID matches in a one-to-one relation with the different digital map patterns used in the MAR system.

In use, the electronic pen 132 is typically used to write on a series of MAR forms 136 in the course of administering medications to a number of patients. Subsequently, the electronic pen 132 is coupled to its respective health care provider workstation 130. The penstroke information recorded in the electronic pen 132 is transmitted to the health care provider workstation 130. The healthcare provider workstation 130 transmits the penstroke information to the MAR data processing module 114 in the administration node 102.

In MAR systems in which a different writing system is used to permit writing directly onto a MAR form and to electronically record electronic information corresponding to the written information, individual MAR forms may be distinguished in a different manner. For example, each MAR form may be assigned a unique paper ID, which is then encoded in a bar code on the MAR form. The bar code can be scanned using the writing instrument in such MAR systems or using a separate scanner to identify the particular MAR form.

Referring again to FIG. 1, pharmacy client node 106 includes a pharmacist workstation 192 and a printer 194 coupled to the pharmacist workstation 192. The pharmacist workstation 192 communicates with the administration node 102 through network 108. In the present embodiment, the pharmacist workstation 192 is operated by a pharmacist. The administration node 102 transmits medication orders to the pharmacist workstation in accordance with prescriptions issued by health care providers. The pharmacist provides medications corresponding to the medication orders to the patient facility at which the respective patient is located (or makes such medications available to be delivered to the patient facility).

One or more medications are administered to one or more patients at each patient facility. A plurality of MAR forms 136 is provided at each patient facility to record the administration of medications to patients. Each medication that is prescribed for a patient is recorded on a MAR form 136. Each time that a nurse or other health care professional administers a dose of a medication to a patient, the health care provider records having done so, as is further described below.

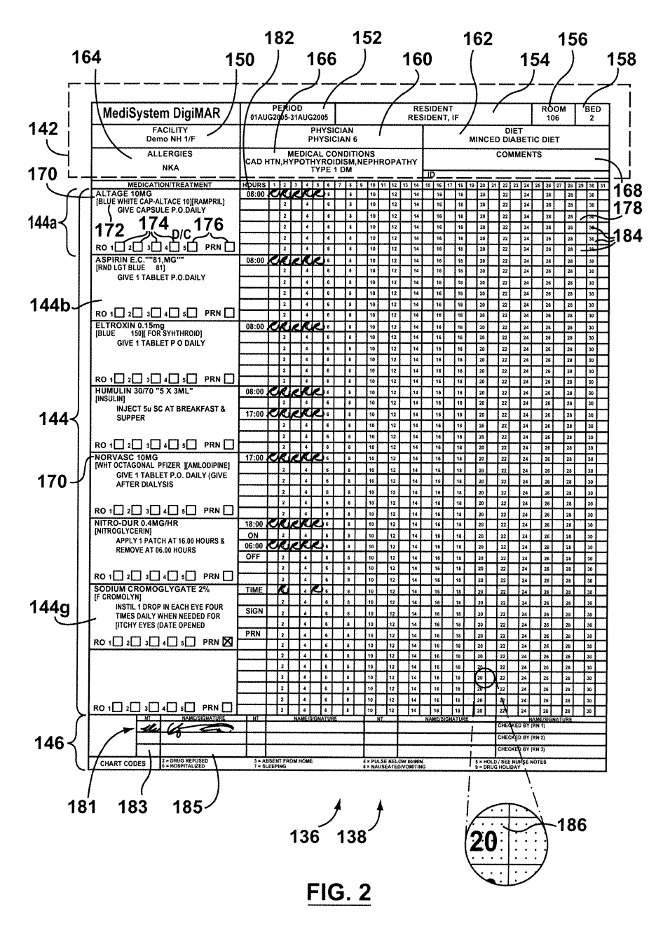

Reference is made to FIG. 2. In the present embodiment, MAR forms are printed on paper. FIG. 2 illustrates an example medication administration form 138, which has a patient information section 142, a plurality of prescription sections 144 and a notations section 146.

Patient information section 142 has several fields in which patient information about the patient is recorded.

| | Contents on Example Form | |
|---|---|---|
| Field | (FIG. 2) | Description of Field |
| Patient facility name | Alpha Nursing Home | Name of the patient facility at |
| field 150 | | which the patient is located. |
| Period field 152 | 01 AUG 2005-31 AUG 2005 | The time period for which the form |
| | | is to be used. |
| Patient (or Resident) | John Smith | Name of the patient. |
| field 154 | | |
| Room field 156 | 106 | Room number in which the patient |
| | | is located. |
| Bed field 158 | 2 | Bed within the room identified in |
| | | the room field 156 |
| Physician field 160 | Dr. Jones | Name of the physician treating the |
| | | patient. |
| Diet field 162 | Minced Diabetic Diet | Description of an dietary |
| | | restrictions on the patient. |
| Allergies field 164 | None | Description of patient's allergies, if |
| | | any. |
| Medical conditions field | CAD, HTN, Hypothyroidism, | Description of the patient's |
| 166 | Nephropathy, Type 1 DM | medical condition. |
| Comments field 168 | Prefers orange juice with | Comments regarding the patient. |
| | meds when possible. | |

The layout and contents of the medication administration form 138 is only an example and in other MAR systems, a medication administration form 138 may have different fields and may have a different layout.

Each prescription section 144 is used to record medication information relating to a patient's prescribed medications. Each prescription section 144 includes a medication field 170, a dosage field 172, a plurality of reorder fields 174a-e, a discontinue field 175, a PRN field 176 and a dosage recordation section 178. The dosage recordation section 178 has a number of rows, each of which has a time or hours field 182 and a series of date/time fields 184 corresponding to each day in the period identified in period field 152. In this case, the period for which medication administration form 138 will be used in August 2005 and there are thirty-one corresponding date/time fields.

Prescription sections 144 may be used for any type of therapeutic treatment in addition to prescribed medicines. For example, counseling or other therapy may be set out in the medication field 170. The date/time fields 184 can be used to mark when the therapeutic treatment was delivered to a patient.

Each medication prescribed for the patient is identified in prescription section 144a. On medication administration form 138, the patient has been prescribed seven medications. The first listed medication is Altace™ and patient is to be administered a 10 mg capsule once daily. This information is recorded in the medication field 170 and the dosage field 172. The patient's daily dosage is to be administered at 8:00 am and this time is indicated in the time field in a row in the dosage recordation section 178. If a medication is to be administered more than one time daily, the time at which each dose of the medication is to be administered is set out in the time field of a different row. The date/time fields 184 corresponding to the first five days of the month have been initialed, indicating that the dose of Altace was administered to the patient. Similarly, the name, dosage and the administration schedule for doses of Aspirin™, Eltroxin™, Humulin™, Norvasc™ and Nitro-Dur™ are set out in different prescription sections 144.

In some cases, a patient will be described a medication on an as “as-needed” or “pro re nata” basis. This type of dosage is typically referred to as “PRN” and a health care provider may administer a dose of the medication when the patient requires it. The example patient John Smith has been prescribed Sodium Cromoglycate 2% (Cromolyn™) on a PRN basis and this is indicated in the seventh prescription section 144g by the check in the PRN field 176 in prescription section 144g. Each time a dosage of Sodium Cromoglycate 2% is administered to the patient, the health care provider initials a box under the appropriate day of the month in the dosage recordation section 178g.

Notations section 146 is used to record notation information and includes several health care provider identification sections 181, each of which includes an initial field 183 and a name/signature field 185. Each health care provider that uses medication administration form 138 enters his or her initials, name and signature in one identification section 181. At the bottom of notations section 146, a number of chart codes are set out. These chart codes can be entered in a time/date field 184 by a health care provider rather than the health care provider's initials (or together with the health care provider's initials) to indicate that the identified situation affected or prevented the administration of a medication to the patient. During the course of the period for which a MAR form is in use, the date/time fields 184 are initialed or completed with a chart code to indicate the administration of prescribed medications to the patient.

Referring still to FIG. 2, Each MAR form 136 in MAR system 100 is printed with a digital map pattern 186 in the background of the form. In this exemplary system, an Anoto digital map pattern is used as described above. In the present embodiment, each form is printed on a blank sheet of paper and the digital map pattern 186 is printed simultaneously with the patient information section 142, the prescription sections 144 and the notations section 146 for the form in a single pass. This allows the digital map pattern to be registered precisely with the different regions and fields on the MAR form. Alternatively, a digital map pattern and the various regions and fields of the MAR form may be printed separately. For example, the digital map pattern may be printed in advance or paper with a digital map pattern printed on it may be obtained. The various regions and fields of the MAR form can then be printed onto the paper overlying the digital map pattern. Alternatively, the fields and regions of the MAR form may be printed onto the paper before the digital map pattern.

Reference is again made to FIG. 1. For each patient, data is recorded in the MAR database module 110. For each patient, data corresponding to the fields on a MAR form are recorded in the MAR database module 110. For example, for patient John Smith, the information set out on medication administration form 138 and in the table above is recorded in the database module 110. For each patient, MAR database module 110 also includes an image of each MAR form 136 for the patient. MAR database module 110 may include any type of database or data recording system. For example, the MAR database module 110 may include a relational database, an XML based data recordal system or a flat-file based database capable of recording data or a combination of these and other data recording elements. A skilled person will be capable of configuring a database module to record patient data in a MAR database module and this is not further described here.

MAR database module 110 may be accessed by various components of the MAR system to store data provided by such components or to provide data requested by such components. The MAR data processing module 114 receives pen stroke information from health care provider workstations 130 and updates data recorded in the MAR database module 110 in accordance with the pen stroke information. Prescription processing module 116 extracts prescription information from the MAR database module 110 and communicates with pharmacy client node 106 to provide medication requests or prescriptions to the pharmacist. The user interface module communicates with the technician workstation to retrieve data from the MAR database module 110 for display on the technician workstation 120 and to record data provided at the technician workstation 120 in the MAR database module 110.

In the present embodiment, MAR forms 136 may be printed at the administration node 102 or at a patient facility client node. MAR forms may be printed for one or more patients at a time. For example, in one embodiment of a MAR system, MAR forms for a particular time period for all patients located at a particular patient facility are printed at the administration node 102 and are delivered to the patient facility in advance of the time period. When a MAR form 136 for a particular patient is printed, various regions and fields of the MAR form may be pre-populated with information recorded in the MAR database module 110. For example, medication administration form 138 may be printed with the patient information section 142 and the medication field 170, dosage field 172 and, where it is required, the PRN field 176 of one or more prescription sections 144 pre-populated based on data recorded in the MAR database module.

In the present embodiment, a MAR form may contain different types of fields, including information only fields, updateable information fields, update only fields and action fields.

The patient facility name field 150 is an example of an information field in this embodiment. The information shown in an information only field does not change. In this embodiment, the name of the patient facility is not expected to change. In other embodiments, it may be possible to change information recorded in an information only field by changing the corresponding information recorded in the MAR database module 110.

The room field 156 is an example of an updateable information field. The room that is assigned to a patient within the patient facility is recorded in the MAR database module 110. Such room assignments may change periodically, and in many cases, the change may occur during a particular time period. In such cases, a health care provider or other person responsible for such room assignments may modify the MAR form to reflect the room change using an electronic pen 132 at a patient facility client node 104. As noted above, the electronic pen of the present embodiment includes an ink based writing component and the change is simply written onto an existing MAR form. Typically, the previous room number will be struck out or crossed out. This manual change is then recorded in the MAR database module 110 as described below and will be reflected in MAR forms 136 printed in the future.

The date/time fields 184 are examples of an update only field. As a health care provider administers each dose of the medications prescribed for a patient, the health care provider marks the relevant date/time field 184 for the appropriate date (and when applicable, the time) for the particular dose that was administered. In the present embodiment, the health care providers initials the data/time field to indicate that a dose was successfully administered to the patient. If a dose is not successfully administered, the health care provider may entering one of the chart codes set out at the bottom of the medication administration form 138 into the respective date/time field 184. At the beginning of the time period for which a particular MAR form will be used, each of the date/time fields 184 is empty since none of the prescribed doses have been administered to the patient. The date/time fields 184 are updated as the time period progresses. Each update is recorded in the MAR database module 110, as is described below. In the present embodiment, if a medication administration form 138 is reprinted during a time period (possibly due to a change in an updateable information field, or due to damage or loss of the MAR form), then any initials or chart codes written into a date/time field 184 may optionally be duplicated on the replacement medication administration form 138.

The reorder fields 174 are examples of action fields. In the present embodiment, a health care provider may mark a reorder field, as has been done in reorder field 174a, when a patient requires an additional supply of a prescribed medication. In response to the marking of a reorder field 174, MAR system places an order with a pharmacist for the additional medication supply. This further described below. Other action fields may result in the MAR system taking other actions. For example, in some embodiments, the patient information section 142 may include a patient discharge field. The patient discharge is marked by a health care provider when a patient is discharged from a patient facility. If the patient discharge field is marked the MAR system may transmit a message to the patient facilities maintenance and/or orderly department to advise those departments that the patient's room should be prepared for another patient.

Some fields on a MAR form may be of a hybrid type. For example, in some embodiments, the room field may be an updateable information field, which may be updated if a patient is moved from one room to another. The room number field may also be an action field and the MAR system may transmit a message to the maintenance department indicating the room vacated by the patient should be prepared from another patient.

Medication administration form 138 is only an example of a MAR form 136. In other embodiments, the organization and the fields shown or provided on a MAR form may be different. In any particular embodiment, a MAR form may or may not have any information only, updateable information or action fields.

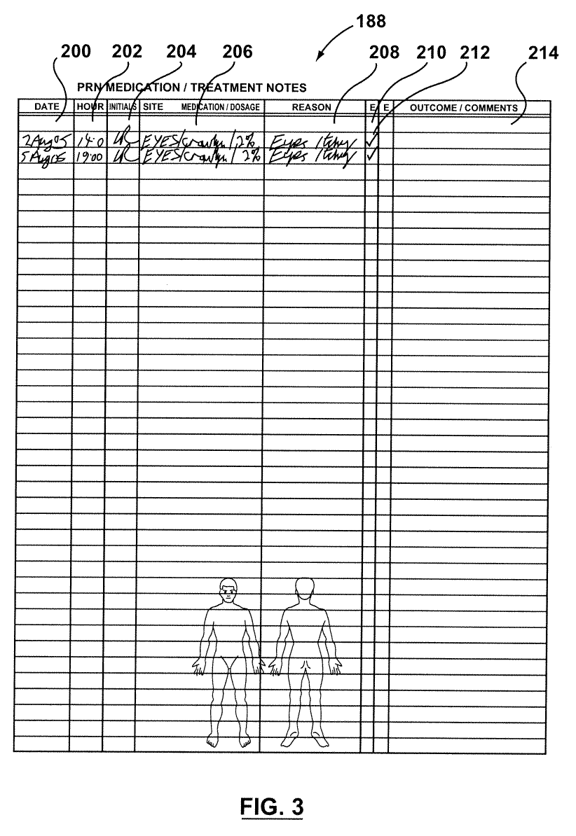

Reference is next made to FIG. 3. When a medication that has been prescribed on an as needed or PRN basis, it is generally desired to record some information relating to the dosage given to a patient. PRN detail form 188, which is another example of a MAR form 136, is used to record such information. In MAR system 100, a PRN detail form 188 is provided for each patient for whom any medication has been prescribed on a PRN basis. The PRN detail form 188 may be printed on the reverse side of a page with the same patient's MAR form on which the prescription for the medication is listed in an prescription section 144, or alternatively may be provided on a different paper. Each PRN detail form 188 includes a unique digital map pattern and any information written onto the PRN detail form 188 with an electronic pen 132 is recorded in the electronic pen and transmitted to the administration node 102. In MAR system 100, each PRN detail form 188 has a number of PRN detail rows 196, each of which has eight fields:

| | Contents in | |
|---|---|---|
| | first row of | |
| | Example Form | |
| Field | (FIG. 3) | Description of Field |
| Date field 200 | Aug. 2, 2005 | Date on which medication was |
| | | administered on a PRN basis |
| Hour field 202 | 14:30 | Time at which medication was |
| | | administered |
| Initials field 204 | See form | Initials of health care provider who |
| | | administered medication |
| Site/Medication/ | Eyes/ | Mode of drug delivery or site on |
| Dosage field 206 | Cromolyn/2% | the body at which the medication |
| | | was administered/name of the |
| | | medication, and the dosage |
| | | administered. |
| Reason field 208 | Headache | Reason for administering |
| | | medication. |
| Effective field 210 | <check mark> | Check if medication was effective. |
| Ineffective field 212 | <blank> | Check if medication was |
| | | ineffective. Typically, only one of |
| | | the effective field 210 or the |
| | | ineffective field 212 will be |
| | | marked. |
| Comments field 214 | <blank> | Additional comments relating to |
| | | the outcome of administering the |
| | | medication or other related issues. |

The layout and contents of the PRN details form 188 is only an example and in other MAR systems, a PRN details form may have different fields and may have a different layout. As with MAR forms 136, the MAR database module 110 includes data corresponding to each field on each MAR form 188. Each MAR form 136 is associated with the patient for whom the MAR form 136 is issued in the MAR database module 110.

When a health care provider administers a drug to a patient on a PRN basis, or attempts to do so, the health care provider records the event as follows: the health care provider enters his or her initials, or an appropriate chart code, in a date/time field 184 in the appropriate prescription section 144 of the patient's medication administration form 138. The health care provider then also enters further information about the event on the patient's PRN detail form 188.

The use of a PRN detail form is optional. In some embodiments, a health care provider provides information relating to the administration of medications on a PRN basis using a web interface to the MAR database module 110 (or the MAR data processing module 114).

In the present embodiment, a medication administration form 138 is used for a time period of one month. In other embodiments, the time period over which a MAR form is used may be different. For example, in some embodiments, a MAR form may be used for only a single day or for many months. If a medication is prescribed for administration to a patient on a PRN basis, the corresponding prescription section 144 may be provided without any preprinted dates or time period. When the prescribed medication is administered to the patient, a health care provider can record the event as described above. Such a field is another example of the type of fields that may be provided on a MAR form. The present invention is not limited to any particular type or types of fields and does not require any particular fields to be included on a MAR form.

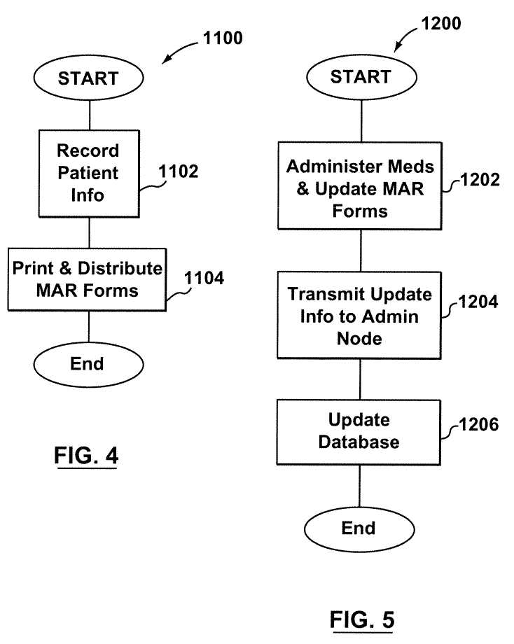

Reference is next made to FIG. 4, which illustrates a method 1100 of providing MAR forms for one or more patients located at a patient facility.

Method 1100 begins in step 1102, in which information relating to each of the patients is recorded in the MAR database module 110 (FIG. 1). User interface module 118 operates on the technician workstation 120 and provides a graphical user interface is provided at the technician workstation 120 to allow a technician or other user to view or modify data recorded in the MAR database module 110. A skilled person will be able to provide such a user interface and it is not further described. The user interface module 118 communicates with MAR database module 110 to retrieve and store data in the MAR database module 110. Using the user interface module 114, a technician records the following information for each patient, to the extent that such information is available: the patient data displayed in the patient information section 142 of a medication administration form 138; and any prescriptions issued for the patient, including the name of the medication, dosage and the course of treatment. If the medication is to be provided on a PRN basis, this is also recorded in the MAR database module 110. This information corresponds to the information printed on medication administration form 138 in the present embodiment. In another embodiment of a MAR system, the data recorded for each patient will depend on the information to be shown on the respective MAR forms for that embodiment.

The MAR database module 110 may also contain additional information about some or all of the patients. For example, the MAR database module 110 may contain credit card information for charging expenses incurred by a patient, the patient's permanent address, next of kin and other contact information. This and other information may be needed or useful for purposes other than the operation of a MAR system, and the MAR database module 110 may be provided within or may be integrated with a database that records such other information.

It will be appreciated that patients are regularly admitted to and discharged from most patient facilities. Information about patients is added and modified as patients are admitted and discharged. For example, each patient's record in the database module may include an “Admitted” field or flag to indicate that a patient has been admitted (when the field or flag is set to “Yes”) or discharged (when the field or flag is set to “No”). As a result, step 1102 will typically be performed with respect to different patients at different times.

Method 1100 next proceeds to step 1104 in which MAR forms 136 are provided to patient facilities. In MAR system 100, a single administration node 102 serves several patient facilities. MAR forms 136 for patients at each facility are printed in advance of the time period in which the MAR forms 136 will be used and are delivered to each patient facility.

In other embodiments there may be more than one administration node and different patient facilities may be served from different administration nodes, or may be served from more than one administration node.

In MAR system 100, there is a single pharmacy client node 106. In other embodiments, there may be more than one pharmacy client node located in more than one pharmacy and prescriptions for patients at different patient facilities may be transmitted to the geographically closest pharmacy. In other systems, prescriptions may be transmitted to a pharmacy where they will filled at the lowest cost or where the required medication is available.

For each patient facility, and for each patient within the patient facility, a MAR technician prints a medication administration form 138 at technician workstation 120. Typically, the user interface provided at the technician workstation 120 will be configured to query the MAR database module 110 to identify patients located at the patient facility. For each such patient, the MAR database module is queried to obtain the information provided in the patient information section 142 and each prescription issued for the patient. A medication administration form is then printed. A record is created in the MAR database module 110 for each MAR form 136 as it is printed. The record identifies the type of MAR form (for example, a medication administration form 138 or a PRN details form 188). Subsequently, an image of the MAR form 136 showing both the regions and fields of the form can be shown with any information written onto the form added to the form. A technician using the technician workstation 120 may thus see an image of a MAR form in its current state, as recorded in the MAR database module 110.

As noted above, each medication administration form 138 has a unique digital map pattern relative to all other MAR forms in MAR system 100. The unique paper ID for the form is assigned to the patient and the association is recorded in MAR database module 110. If a patient has more prescriptions than will fit on a single medication administration form 138, multiple medication administration forms 138 may be printed for the patient. Each such medication administration form 138 will have a unique digital map pattern and a unique paper ID and each such paper ID will be associated with the patient in the MAR database module 110. If any medications are prescribed for the patient on a PRN basis, a PRN detail form 188 is also printed for the patient. The PRN detail form will also have a unique digital map pattern relative to all other MAR forms in MAR system 100 and an association between the corresponding unique paper ID and the patient is recorded in database module 110.

In MAR system 100, a PRN detail form 188 is only printed for a patient who has at least one prescription on a PRN basis. In other embodiments, a PRN detail form 188 may be provided for all patients on the reverse side of a medication administration form 138 or on a separate sheet.

Each of the MAR forms 136 prepared for a particular time period is provided to the appropriate patient facility.

Method 1100 then ends.

Reference is next made to FIG. 5, which illustrates a method 1200 for use of MAR forms 136 at a patient facility and for updating the MAR database module 110. Method 1200 also allows updated MAR forms to be provided.

Method 1200 begins in step 1202, in which a health care provider prepares for a periodic round of administering medications to patients at the patient facility. The health care provider gathers the chart for each of the patients to whom a medication is to be administered. Each patient's chart contains the patient MAR form for the current time period. The health care provider then visits each of the patients and attempts to administer the appropriate medication or medications to the patient. As the health care provider administers each dose to each patient, the health care provider marks the appropriate time/date field 184 on the patient's medication administration form 138 with either the health care providers initials or the appropriate chart code, depending on whether the medication was successfully administered to the patient.

Typically a patient facility client node 104 will be located in each such area. Alternatively, health care providers in different areas may share a single patient facility client node 104. In some embodiments, a single patient facility client node 104 may have more than one electronic pen coupled to it, allowing more than one health care provider to administer medications to patients at a time and to simultaneously update their patient's respective MAR forms 136.

The health care provider uses the electronic pen 132 of the patient facility client node 104 for the appropriate area to mark the MAR forms 136. The electronic pen 132 records penstroke information corresponding to information written on the MAR forms 136 in any field, as described above.

Method 1200 then proceeds to step 1204. When the health care provider has finished administering medications to patients, the health care provider couples the electronic pen 132 to its respective health care practitioner workstation 130. The penstroke information is transmitted from the electronic pen 132 to the health care practitioner workstation 130 and to the MAR data processing module 114 of the administration node 102.

Method 1200 then proceeds to step 1206, in which the penstroke information is processed. The MAR data processing module converts the penstroke information for each MAR form 136 into corresponding markings and information, which is then added to the existing record for the MAR form 136 in the MAR database module 110.

The MAR data processing module also examines the penstroke information for each MAR form 136. In some cases, an automatic action may be triggered in response to the penstroke information.

For example, if a health care provider has marked a reorder field 174 on a MAR form, the MAR data processing module transmits a message to the prescription processing module 116 indicating that a medication is to be ordered. In MAR system 100, the message identifies the patient and the medication to be ordered. The prescription processing module 116 then obtains any additional information required to order the medication from the MAR database module 110. The prescription processing module 116 then transmits a prescription request to the pharmacist client node 106. At the pharmacy client node, the pharmacist workstation receives the prescription. A pharmacist may review the prescription on a display screen on the workstation or print the prescription, or both. The pharmacist then fills the prescription and provides the medication required for the patient to the appropriate patient facility. In this way, a medication reorder can be processed promptly after it is requested by the health care provider.

Other automatic actions include sending a message to a housekeeping, maintenance or orderly department to clean a room when a patient is discharged, which may be indicated by marking a discharge field on a MAR form.

In some cases, an action may be required by a technician in response to the information marked on the MAR form, the data processing module indicates this to the technician. The indication may take the form of an alarm, an e-mail or the indication may be added to a list of indications that the technician periodically reviews. Any other form of indicating that an action is required may be used in a MAR system 100.

If an updateable information field is updated by a health care provider, the technician manually updates the corresponding data in the MAR database module 110 using the technician workstation 120. This leaves the data in the MAR database module 110 matching the data on the corresponding MAR form 136.

In some cases, an action field may be marked, but the required action might have to be initiated by a technician. For example, if a patient is moved from one room to another, the technician will update the MAR database to identify the patient's new room number. The technician may manually request that the vacated room be cleaned.

In MAR system 100, a technician also records the initials or chart codes entered into date/time field 184 and other update fields (such as the initials and name fields 183 and 185 in the notations section 146 (FIG. 2)) in the MAR database module 110. This information is thus recorded in two forms in the MAR database module 110. The information is recorded as part of the image and in the data fields corresponding to the field on the MAR form.

In other MAR systems, initials or chart codes entered into the date/time fields 184 may not be recorded in specific data fields in the MAR database module and only an image corresponding to writing in the fields may be recorded.

In the present embodiment, it is not necessary to print a new MAR form 136 setting out the new data. Instead, the original MAR form can continue to be used at the patient facility. Optionally, a new MAR form 136 may be provided. If a new MAR form 136 is printed, the new form contains updated information for the updateable information fields. The handwritten modification is removed from the image of the MAR form is not printed on the new form. For update only fields, the new form may optionally contain an image of the handwritten information entered in the update only fields by a health care provider since the MAR form (or a previously replacement MAR form) was initially issued.

Method 1200 then ends.

Method 1200 allows data corresponding to a MAR form 136 to be updated either automatically or manually soon after a health care provider modifies the MAR form. The short latency between changes to a MAR form and the update of the recorded version of the firm also allows actions requested on the MAR form to be carried out with less delay than in prior art systems.

In MAR system 100 a technician manually transcribes initials, chart codes and other changes from the image of a MAR form 136 into the MAR database module 110. In other embodiments, a hand writing recognition system may be used to identify the information written by a health care provider in some or all of the fields of the MAR form and the MAR database module 110 may automatically be updated. In some embodiments, the hand writing recognition system may be used to prepare an update for the MAR database module, but the update may be delayed until the accuracy and scanned information is confirmed by a technician.

In MAR system 100, some of the health care provider workstations 130 may be provided with a printer 133. The health care provider workstations may include a health care provider user interface that allows the health care provider to print a MAR form 136 at the patient facility. The information required to print a MAR form is extracted from the image of the MAR form in the MAR database module and from the corresponding data recorded in the MAR database module 110. This data is transmitted from the administration node 102 to the patient facility client node 106, where it is printed on the printer 133.

In MAR system 100, the electronic pen 132 may optionally be configured to record the time at which each pen stroke recorded by the electronic pen was originally made by a health care provider. This information may be retained in the MAR database module 110 and may be used to analyze the administration of medications to patients. In step 1206, the time stamp for each penstroke recorded in the image of each MAR form may be retained as meta-data for the penstroke in the MAR database module 110. In addition, the time stamp may be associated with the corresponding data in the corresponding data fields in the MAR database module. Subsequently, the time at which each medication was administered to a patient may be compared to the time at which it was intended to be administered and report may be generated to summarize this information for one or more patients.

In other embodiments, a MAR system may also provide other reports. For example, a missing signature report may be generated to identify any past due medication doses that have not been administered to a patient. This report is generated by determining whether any date/time fields 184 corresponding to a past dosage time for a medication have not been initialed or otherwise completed with a chart code. This report can be used to provide any missed doses to a patient and other purposes.

A PRN reminder report may be printed by identifying any medications administered on a PRN basis. If corresponding information is not provided on a PRN detail page (or on a web interface for entering such date, as described above) then the missing PRN details can be identified as missing and a health care provider can be prompted to provide the details.

A medication rounds report can be generated using the time field 182 and the corresponding information in the database module 110. A list of patients and corresponding medications to be administered over an upcoming time period can be generated. Such a list may be used to assemble medications required during a round of patient visits and medication administrations.

In a MAR system, these reports may be printed at the technician workstation 120 or at a health care provider workstation 130.

In MAR system 100, one or more MAR forms 136 may be printed for patients that are newly admitted to a patient facility. When a patient is admitted, an appropriate MAR form 138 is printed setting out any medications or treatments prescribed for the patient. If the new patient has any prescriptions on a PRN basis, a PRN details form 188 is also printed.

In some embodiments, a patient facility may be provided with blank MAR forms 136, which a health care provider may use for a new patient (or in the place of a lost or damaged MAR form). The health care provider may complete some or all of the patient information section 142 and any prescription sections 144 as needed. Subsequently, the electronic pen used to complete the forms will transmits penstroke information corresponding to the information written on the blank form to the MAR data processing module, which will provide an image of the writing. A technician may manually enter the written information into the MAR database module 110, or alternatively or in addition, a handwriting recognition module may update the MAR database module 110. The paper ID for any new MAR forms used for a particular patient are also associated with the patient in the MAR database module 110.

The present invention has been described here by way of example only. Various modification and variations may be made to these exemplary embodiments without departing from the spirit and scope of the invention, which is limited only by the appended claims.

1. A system for maintaining medication administrator records comprising:
an administration node including:
a MAR database module for recording information relating the administration of medications to patients; and
a MAR data processing module for receiving pen stroke information and for recording data corresponding to the pen stroke information in the MAR database module;
one or more patient facility client nodes, each of the patient facility client nodes including:
a writing system adapted to record pen stroke corresponding to information written by a health care provider onto a MAR form; and
a health care provider workstation adapted to receive the pen stroke information from the writing system and to transmit the pen stroke information to the MAR data processing module.

2. (canceled)

3. The system of claim 1 further including a plurality of MAR forms corresponding to patients, wherein each of MAR forms includes one or more fields for recording medication information relating to the administration of medication to a respective patient, and wherein the MAR database includes a data field for recording data corresponding to the medication information.

4. The system of claim 3 wherein the MAR data processing module is configured to convert the pen stroke information into an image of the MAR form including the medication information to which the pen stroke information corresponds and to record the image in the MAR database module.

5. The system of claim 4 wherein the MAR data processing module progressively updates the image of the MAR form in response to additional pen stroke information corresponding to additional medication information being written onto a corresponding MAR form.

6. The system of claim 1 wherein the MAR form includes a digital map pattern, and wherein the writing system includes an electronic pen adapted to electronically record the pen stroke information by optically scanning the digital map pattern.

7. The system of claim 4 wherein the image is converted into data recorded in data field in the MAR database module through a manual transcribing process.

8. The system of claim 4 wherein the MAR database module is configured to convert the pen stroke information into data corresponding to the medication information and to record the data in the MAR database module.

9. The system of claim 8 wherein the MAR database module includes a hand writing recognition module for converting the pen stroke information into data corresponding to the medication information.

10. The system of claim 1 further including a prescription processing module for providing prescription information to a pharmacy.

11. The system of claim 1 wherein at least some of the MAR forms include an action field and wherein, in response to medication information being written into the action field, a corresponding action is taken.

12. The system of claim 1 wherein each of MAR forms includes a patient information section having a plurality of fields relating to a patient, wherein the field are automatically populated with information relating to the patient.

13. The system of claim 1 wherein each of the MAR forms includes one or more prescription section have a plurality of fields relating to medications prescribed for the patient, wherein at least some of the field are automatically populated with information relating to the patient's medications.

14. The system of claim 13 wherein the fields in the prescription section include a medication field for identifying a medication prescribed for the patient and a dosage field for setting out a prescribed dosage and a plurality of date/time fields for marking the administration of a dose of the medication.

15. The system of claim 13 wherein the fields in the prescription section include a reorder field, and wherein the administration node is configured to automatically order an additional supply of the corresponding medication if the reorder field is marked.

16. A method of maintaining medication administration records comprising:
providing one or more forms, wherein each of the MAR forms corresponds to a patient;
receiving pen stroke information corresponding to medication information written by a health care provider onto a particular MAR form;
combining the pen stroke information with an existing image of the particular MAR to provide an updated image of the particular MAR form wherein the updated image includes the medication information.

17. The method of claim 16 wherein each MAR form is associated with the corresponding patient if a MAR database module.

18. The method of claim 16 wherein an image of each MAR form is recorded in a MAR database module and is associated with the corresponding patient in the MAR database module.

19. The method of claim 18 wherein providing an updated image includes updating the image of the MAR form in the MAR database module.

20. The method of claim 16 further including converting the pen stroke information into data corresponding to the medication information and recording the data into a data field in the MAR database module.

21. The method of claim 16 wherein the MAR form includes at least one reorder action field in a medication section, and wherein the medication section corresponds to a particular medication prescribed for a respective patient, the method further comprising:
analyzing the pen stroke information to determine whether the reorder action field has been marked;
if the reorder action field has been marked, then ordering an additional supply of the medication from a pharmacy.

22. The method of claim 20 wherein the additional supply of the medication is automatically ordered using previously recorded patient information.

23. The method of claim 16 wherein providing one or more MAR forms including, for each of the patients, printing one or more MAR forms containing patient information and medication information specific to the patient.

24. The method of claim 23 wherein the patient information and medication information specific to the patient is obtained from a MAR database module.

25. The method of claim 16 further including printing a replacement MAR form corresponding to an original MAR form, including printing information written or marked on the original MAR form onto the replacement MAR form.
